(19) United States
(12) Patent Application Publication
(10) Pub. No.: US 2020/0024033 A1
(43) Pub. Date: Jan. 23, 2020

(54) CYLINDRICAL GREETING CARD SYSTEM AND METHOD OF USE

(71) Applicant: PAUL WESTRAY SHARPE, LANGLEY (CA)

(72) Inventor: PAUL WESTRAY SHARPE, LANGLEY (CA)

(21) Appl. No.: 15/831,689

(22) Filed: Dec. 5, 2017

(51) Int. Cl. B65D 23/14; G09F 3/10

(52) U.S. Cl. CPC B65D 23/14; G09F 2003/0273; G09F 3/10

(57) ABSTRACT

A greeting card system including a flexible sheet having a front-surface and a rear-surface, a first-fastener, and a second-fastener. The front-surface of the flexible sheet includes indicia a greeting and a blank message box for applying a personal functional message. The flexible sheet is configured to be manipulated into a cylindrical profile having the first-edge and the second-edge proximal to one another. The flexible sheet is may be applied to an outer surface of the wine bottle and may be removed and placed on a substantially planar surface.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### FIELD OF THE INVENTION

The present invention relates generally to the field of cards and gift wrapping and more specifically relates to a novel greeting card means.

### DESCRIPTION OF RELATED ART

Greeting cards are well known in the art. Such cards are tailored for a particular occasion, i.e., birthday, wedding, graduation, and can be further classified into various subcategories i.e., son, daughter, cousin, parent, grandparent, and so forth. When a gift is given, it is customary to wrap the gift and attach a card. An unwrapped gift may imply that the gift was purchased at the last minute, or may convey insensitivity in that the gift giver is unwilling to go through the effort of wrapping the gift. An attached card allows the gift giver to express a personalized message to the recipient, and provides a practical way of identifying who gave the gift. Cards are often given with gifts and can easily get lost in the mix of several gifts at a party or event. Cards also curl and may fall down when set on a shelf or other surface. A suitable solution is desired.

U.S. Pub. No. 2008/0209779 to Sharon Mirande relates to a greeting label. The described greeting label includes a greeting label for placement over the original label of a bottle, such as a bottle of wine or champagne. The label typically has an adhesive on the back face and indicia such as a greeting and a decorative design on the front face. A removable panel typically is adhered to the back face prior to use and then removed so that the adhesive is exposed prior to applying the label to the bottle. The greeting label may be pre-packaged as a kit, and can include a plurality of decorative labels for placing on the bottle.

### BRIEF SUMMARY OF THE INVENTION

In view of the foregoing disadvantages inherent in the known cards and gift wrapping art, the present disclosure provides a novel cylindrical greeting card system and method of use. The general purpose of the present disclosure, which will be described subsequently in greater detail, is to provide a cylindrical greeting card and custom bottle greeting card.

A cylindrical greeting card system is disclosed herein. The cylindrical greeting card system includes a cylindrical greeting card system comprising a flexible sheet having a front-surface and a rear-surface, a first-fastener, and a second-fastener. The flexible sheet is defined by the front-surface, the rear-surface, the first-edge, and the second-edge. The first-fastener is positioned on a first-edge of the rear-surface, and the second-fastener is positioned on a second-edge of the rear-surface. The first-fastener and the second-fastener each comprise a removeable panel. The front-surface of the flexible sheet includes indicia for displaying a greeting for various occasions and holidays and a blank message box for applying a personal functional message. The flexible sheet is configured to be manipulated into a cylindrical profile having the first-edge and the second-edge proximal to one another. The first-fastener and the second-fastener preferably comprise adhesive or other suitable fastening means.

A first-removeable-panel is adapted to be placed over the first-fastener and a second- removeable-panel the second-fastener to cover the adhesive before use. The first-fastener and the second-fastener comprise an elongated profile extending along a length of the first-edge and the second-edge of the rear-surface. The first-fastener is configured to be attached to an opposing edge of the flexible sheet creating the cylindrical profile configured to be secured around a wine bottle.

A kit is also disclosed herein including a gift bottle bag, a flexible sheet, a fastener, and a set of instructions.

A method of using the cylindrical greeting card system is also disclosed herein. The method of using cylindrical greeting card system may comprise the steps of: providing a flexible sheet having a front-surface and a rear-surface, a first-fastener, and a second-fastener, writing a personal functional message, wrapping the flexible sheet around a bottle, removing a first-removeable-panel from a first-fastener, securing opposing edges of the flexible sheet around the bottle, removing a second-removeable-panel from a second-fastener, securing a second-fastener to the bottle, and removing the flexible sheet from the bottle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a cylindrical greeting card system and method of use, constructed and operative according to the teachings of the present disclosure.

FIG. 1 is a perspective view of the cylindrical greeting card system during an ‘in-use’ condition, according to an embodiment of the disclosure.

FIG. 2 is a perspective view of the cylindrical greeting card system of FIG. 1, according to an embodiment of the present disclosure.

FIG. 3 is a perspective view of the cylindrical greeting card system of FIG. 1, according to an embodiment of the present disclosure.

FIG. 4 is a perspective view of the cylindrical greeting card system of FIG. 1, according to an embodiment of the present disclosure.

FIG. 5 is a flow diagram illustrating a method of use for the cylindrical greeting card system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to cards and gift wrapping and more particularly to a cylindrical greeting card system and method of use as used to improve the use of greeting by providing a cylindrical greeting card system for placement over the original label of a bottle, such as a bottle of wine or champagne. The bottles may have different sizes and profiles/cross-sections.

Generally, the cylindrical greeting card system is a greeting card that is made into a cylinder (with no bottom, suited to fit about a cylindrical bottle) using double side tape on the back. The cylindrical greeting card system is the card that never falls down. The card may be used to attach to a bottle of alcohol when giving as a present. The cylindrical greeting card system has two strips of double sided tape on the back of the card. One strip is for making the cylindrical shaped card and/or use as a bottle wrapper. The second strip is only used to attach to a very large bottle so it sticks directly to the bottle. The card fixes the problem of not falling off a mantle place when the normal paper cards dries out and curls up and falls off the shelf.

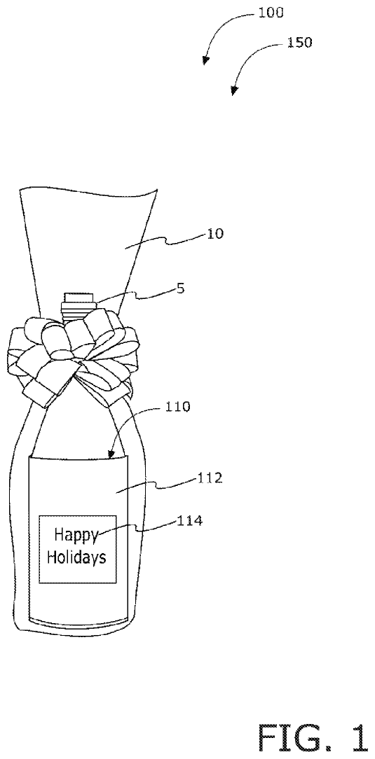

Referring now more specifically to the drawings by numerals of reference, there is shown in FIGS. 1-4, various views of a cylindrical greeting card system 100. FIG. 1 shows a cylindrical greeting card system 100 during an ‘in-use’ condition 150, according to an embodiment of the present disclosure. As illustrated, the cylindrical greeting card system 100 may include a flexible sheet 110 having a front-surface 112 and a rear-surface 116, a first-fastener 120, and a second-fastener 130. The flexible sheet 110 is defined by the front-surface 112, the rear-surface 116, a first-fastener 120, and a second-fastener 130. The first-fastener 120 is positioned on a first-edge 122 of the rear-surface 116, and the second-fastener 130 is positioned on a second-edge 132 of the rear-surface 116. The first-fastener 120 and the second-fastener 130 each comprise a removeable panel 160. The front-surface 112 of the flexible sheet 110 comprises indicia 114 for displaying a greeting. The front-surface 112 of the flexible sheet 110 further comprises a blank message box 115 for applying a personal functional message.

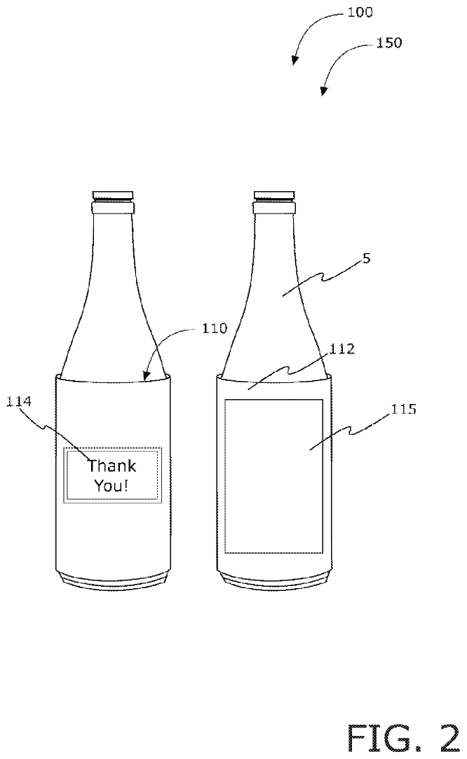

FIG. 2 shows a front perspective view of the cylindrical greeting card system 100 of FIG. 1, according to an embodiment of the present disclosure. As above, the cylindrical greeting card system 100 may include the flexible sheet 110 having the front-surface 112 and the rear-surface 116, the first-fastener 120, and the second-fastener 130. The flexible sheet 110 is configured to be manipulated into a cylindrical (circular without a bottom in preferred embodiments) profile having the first-edge 122 and the second-edge 132 proximal to one another. The first-fastener 120 and the second-fastener 130 comprise adhesive. A first-removeable-panel 124 is adapted to be placed over the first-fastener 120 and a second-removeable-panel 134 the second-fastener 130 to cover the adhesive before use. The first-fastener 120 and the second-fastener 130 comprise an elongated profile extending along a length of the first-edge 122 and the second-edge 132 of the rear-surface 116. The first-fastener 120 is configured to be attached to an opposing edge of the flexible sheet 110 creating the cylindrical profile configured to be secured around a standard sized wine bottle 5 (minimum size of 650 milliliters and a maximum size of 750 milliliters). The rear-surface 116 comprises instructional-indicia 118.

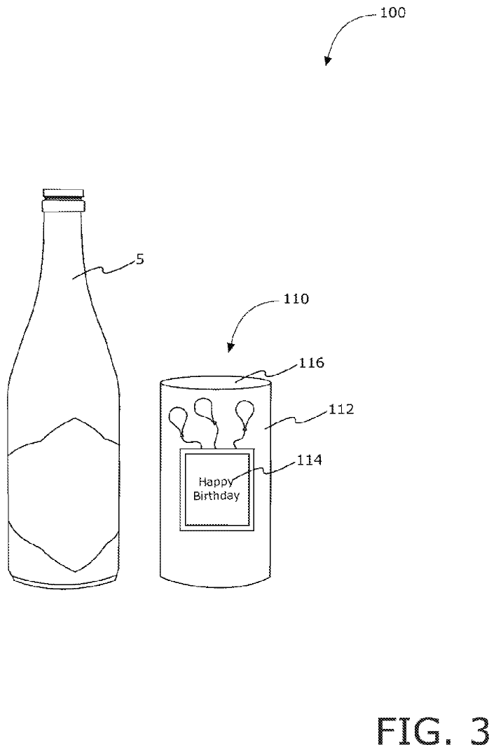

Referring now to FIG. 3 showing a front perspective view of the cylindrical greeting card system 100 of FIG. 1, according to an embodiment of the present disclosure. As above, the cylindrical greeting card system 100 may include the flexible sheet 110 having the front-surface 112 and the rear-surface 116, the first-fastener 120, and the second-fastener 130 which may be secured to itself or secured directly to a wine bottle 5 or other gift bottle. The first-fastener 120 and the second-fastener 130 are adjustably configured to be adhered directly to a larger wine bottle 5 (minimum size of 1 liter and a maximum size of 1.5 liter bottle) when the removeable panel 160 is removed from the first-fastener 120 and the second-fastener 130 if a diameter of the wine bottle 5 is too large to be entirely encircled by the flexible sheet 110.

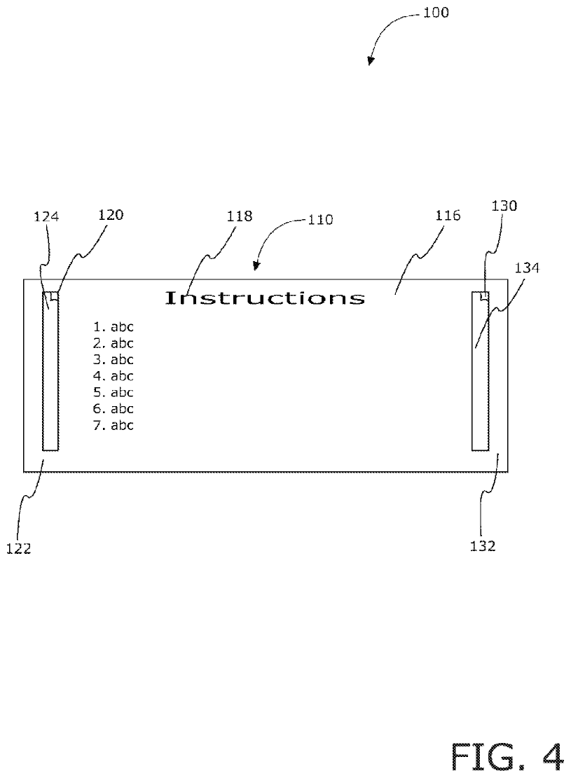

FIG. 4 shows a front perspective view of the cylindrical greeting card system 100 of FIG. 1, according to an embodiment of the present disclosure. As above, the cylindrical greeting card system 100 may include the flexible sheet 110 configured to be applied to an outer surface of the wine bottle 5. The wine bottle 5 or gift bottle may have a cylindrical-profile and alternately a non-cylindrical-profile. The flexible sheet 110 comprises an elongated rectangular body. The flexible sheet 110 is planar during a non-use condition. The cylindrical profile comprises a slightly larger diameter than the wine bottle 5 allowing the flexible sheet 110 to be removeable from the wine bottle 5. The flexible sheet 110 when the first-fastener 120 is attached to the opposing edge of the flexible sheet 110 creating a profile suitable to form about a cylindrical item (bottle or the like, but not limited to bottles or cylindrical bottles); the flexible sheet 110 is configured to provide a self-supporting greeting card to be placed on a substantially planar surface.

According to one embodiment, the cylindrical greeting card system 100 may be arranged as a kit. In particular, the cylindrical greeting card system 100 may further include a gift bottle bag 10, a flexible sheet 110, a fastener such as a twist tie, and a set of instructions. The instructions 107 may detail functional relationships in relation to the structure of the cylindrical greeting card system 100 such that the cylindrical greeting card system 100 can be used, maintained, or the like, in a preferred manner. The kit may also include the bottle in combination for sale.

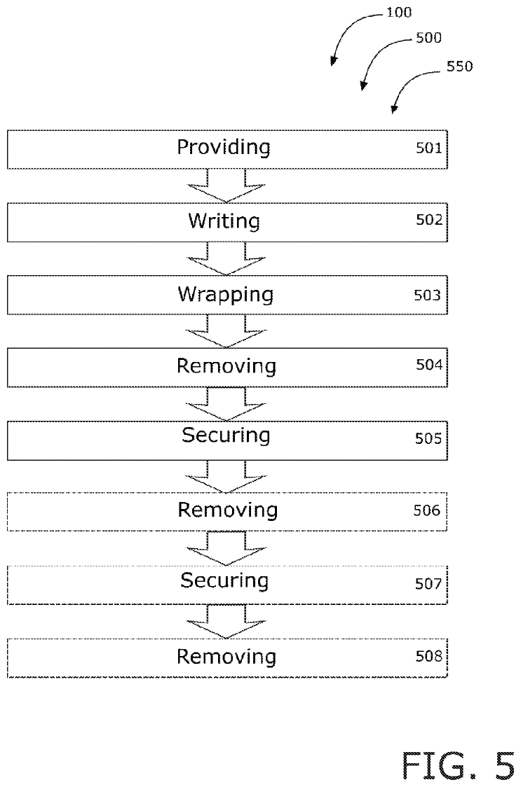

FIG. 5 is a flow diagram 550 illustrating a method of gift wrapping a container having an outer periphery 500, according to an embodiment of the present disclosure. As illustrated, the method of gift wrapping a container having an outer periphery 500 may include the steps of: step one 501, providing a flexible sheet 110 having a front-surface 112 and a rear-surface 116, a first-fastener 120, and a second-fastener 130; step two 502, writing a personal functional message; step three 503, wrapping the flexible sheet 110 around a bottle 5; step four 504, removing a first-removeable-panel 124 from a first-fastener 120; step five 505, securing opposing edges of the flexible sheet 110 around the bottle 5; step six 506, removing a second-removeable-panel 134 from a second-fastener 130; step seven 507, securing a second-fastener 130 to the bottle 5; and step eight 508, removing the flexible sheet 110 from the bottle 5.

It should be noted that steps six 506, seven 507 and eight 508 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for cylindrical greeting card system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A cylindrical greeting card system comprising:
a flexible sheet having;
a front-surface comprising:
front-surface indicia comprising:
a greeting structured and arranged for various occasions and holidays; and
a blank message box structured and arranged for applying a personal functional message; and
a rear-surface comprising:
a first-edge and further comprising a second-edge; and
instructional indicia;
a first-fastener comprising a first removable panel; and
a second-fastener comprising a second removable panel;
wherein said flexible sheet is defined by said front-surface, said rear-surface, said first-fastener, and said second-fastener;
wherein said first-fastener is positioned on said rear-surface adjacent to said first-edge, and said second-fastener is positioned on said rear-surface adjacent to said second-edge;
wherein said flexible sheet is configured to be manipulated into a cylindrical profile having said first-edge and said second-edge proximal to one another; and
wherein said rear-surface lacks any fasteners between said first-fastener and said second-fastener.

2. The cylindrical greeting card system of claim 1, wherein said first-fastener and said second-fastener comprise adhesive.

3. The cylindrical greeting card system of claim 2, wherein a first-removeable-panel is adapted to be placed over said first-fastener and a second-removeable-panel said second-fastener to cover said adhesive before use.

4. The cylindrical greeting card system of claim 3, wherein said first-fastener and said second-fastener comprise an elongated profile extending along a length of said first-edge and said second-edge of said rear-surface.

5. The cylindrical greeting card system of claim 1, wherein said first-fastener is configured to be attached to an opposing edge of said flexible sheet creating said cylindrical profile configured to be secured around a wine bottle.

6. The cylindrical greeting card system of claim 1, wherein said first-fastener and said second-fastener are adjustably configured to be adhered directly to a larger said wine bottle when said first removable panel is removed from said first-fastener and said first removable panel is removed from said second-fastener if a diameter of said wine bottle is too large to be entirely encircled by said flexible sheet.

7. (canceled)

8. (canceled)

9. (canceled)

10. (canceled)

11. (canceled)

12. The cylindrical greeting card system of claim 1, wherein said flexible sheet comprises an elongated rectangular body.

13. The cylindrical greeting card system of claim 1, wherein said flexible sheet is planar during a non-use condition.

14. The cylindrical greeting card system of claim 1, wherein said flexible sheet when said first-fastener is attached to said opposing edge of said flexible sheet creating a cylindrical profile is configured to provide a self-supporting greeting card to be placed on a substantially planar surface.

15. The cylindrical greeting card system of claim 5, wherein said flexible sheet is removeable from said wine bottle.

16. The cylindrical greeting card system of claim 14, wherein said cylindrical profile comprises a slightly larger diameter than a wine bottle.

17. A greeting card system able to circumscribe a wine bottle, the greeting card system comprising:
a flexible sheet having;
a front-surface comprising:
a greeting structured and arranged for various occasions and holidays; and
a blank message box structured and arranged for applying a personal functional message; and
a rear-surface comprising:
a first-edge and further comprising a second-edge; and
instructional indicia;
a first-fastener comprising a first removable panel; and
a second-fastener comprising a second removable panel;
wherein said flexible sheet is defined by said front-surface, said rear-surface, said first-fastener, and said second-fastener;
wherein said first-fastener is positioned on said rear-surface adjacent to said first-edge, and said second-fastener is positioned on said rear-surface adjacent to said second-edge; and
wherein said rear-surface lacks any fasteners between said first-fastener and said second-fastener;
wherein said flexible sheet is planar during a non-use condition;
wherein said flexible sheet is configured to be manipulated into a circular profile about a cylindrical object having said first-edge and said second-edge proximal to one another;
wherein said flexible sheet comprises an elongated rectangular body;
wherein said first-fastener and said second-fastener comprise adhesive;
wherein said first-fastener and said second-fastener each comprise a removeable panel;
wherein said first removable panel is adapted to be placed over said first-fastener and said second removable panel is adapted to be placed over said second-fastener to cover said adhesive before use;
wherein said first-fastener and said second-fastener comprise an elongated profile extending along a length of said first-edge and said second-edge of said rear-surface;
wherein said first-fastener is configured to be attached to an opposing edge of said flexible sheet creating said circular profile configured to be secured around a wine bottle;
wherein said front-surface of said flexible sheet further comprises a blank message box for applying a personal functional message;
wherein said flexible sheet is configured to be applied to an outer surface of said wine bottle;
wherein said flexible sheet when said first-fastener is attached to said opposing edge of said flexible sheet creating a circular profile is configured to provide a self-supporting greeting card to be placed on a substantially planar surface;
wherein said flexible sheet is removeable from said wine bottle; and
wherein said circular profile comprises a slightly larger diameter than said wine bottle.

18. The greeting card system of claim 17, further comprising a bottle of wine, a gift bottle bag, a set of instructions; and
wherein the cylindrical greeting card system is arranged as a kit.

19. A method of gift wrapping a container having an outer periphery, the method utilizing the greeting card system of claim 17 and comprising the steps of:
providing the greeting card system of claim 17;
writing a personal functional message;
wrapping said flexible sheet around a bottle;
removing said first removable panel of said flexible sheet from a said first-fastener of said flexible sheet; and
securing each of said first-edge of said flexible sheet and said second-edge of said flexible sheet around said bottle.

20. The method of claim 19, further comprising the steps of:
removing said second removable panel of said flexible sheet from a second-fastener;
securing said second-fastener of said flexible sheet to said bottle; and
removing said flexible sheet from said bottle.
